(19) United States
(12) Patent Application Publication
(10) Pub. No.: US 2025/0137952 A1
(43) Pub. Date: May 1, 2025

(54) APPARATUS FOR DETERMINING THE THERMAL INSULATION PROPERTIES OF VACUUM INSULATION ELEMENTS

(71) Applicant: va-Q-tec Thermal Solutions GmbH, Würzburg (DE)

(72) Inventors: Lukas Schleelein, Würzburg (DE); Anton Landmann, Würzburg (DE); Christoph Greiner, Würzburg (DE); Klaus Heil, Würzburg (DE); Nicola Brzoska-Steinhaus, Würzburg (DE)

(21) Appl. No.: 18/931,939

(22) Filed: Oct. 30, 2024

(30) Foreign Application Priority Data
Oct. 30, 2023 (DE) 10 2023 129 937.9

(51) Int. Cl. G01N 25/18; B60P 3/20

(52) U.S. Cl. CPC G01N 25/18; B60P 3/20

(57) ABSTRACT

Apparatus for determining the thermal insulation properties of vacuum insulation elements, comprising at least one vacuum insulation element having a first side surface and a second side surface, at least one temperature-measuring sensor which is arranged on the first side surface and/or the second side surface, and a data processing unit for receiving, evaluating and outputting the temperature data provided by the temperature-measuring sensor.

### CROSS-REFERENCE TO RELATED APPLICATIONS

This patent application claims priority to German utility patent application number 10 2023 129 937.9 filed Oct. 30, 2023, and titled “apparatus for determining the thermal insulation properties of vacuum insulation elements.” The subject matter of patent application number 10 2023 129 937.9 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention relates to an apparatus for determining the thermal insulation properties of vacuum insulation elements.

The invention pertains to the technical field of quality control using temperature measurements performed on insulation materials, e.g. vacuum insulation panels, which are used, for example, for temperature-controlled transport in containers or boxes

### BACKGROUND

The quality of insulation materials such as vacuum insulation panels significantly determines their thermal insulation properties (insulation quality or grade) and thus the quality of goods that are transported in thermal insulation containers, for example. Over time, the quality gradually deteriorates due to the outgassing of the materials contained in the vacuum insulation panels and surfaces and/or diffusion through the sealing walls (e.g. a high-barrier film). As a result of mechanical defects, such as hairline cracks or severe damage, the insulation quality can also deteriorate very quickly. This results in increased heat input, which impairs the insulation properties and consequently leads to a loss of quality in the transported goods. This must be avoided or monitored and controlled.

One possibility is to monitor the gas pressure and to adjust it accordingly in the event of fluctuations. The insulation quality can be restored by evacuating the vacuum chamber again. However, the evacuation process is complex and time-consuming. To measure internal gas pressures in the range of 10-4 mbar, sensitive and expensive sensors and evaluation units are required, such as Pirani vacuum gauges, which can be used up to minimum pressures of 10-4 mbar, or ionization vacuum gauges, which are used to determine pressure in the high and ultra-high vacuum range, i.e. from approx. 10-3 to 10-12 mbar. However, these measuring methods are expensive and, in particular, unsuitable for use in mobile applications such as temperature-controlled transport in containers or boxes.

Other methods make use of the temperature progression (a plurality of temperatures) given at selected measuring points on the double-walled container and/or within the double-walled container (e.g. measuring points on heat insulation layers of a multi-layer insulation, on heat radiation shields, on the inner wall and/or on the outer wall) as a measured variable for detecting a variation in the heat flows through the vacuum insulation of double-walled vacuum-insulated containers.

In JP 2006-078190 A, a system is described in which a temperature sensor is arranged in a vacuum chamber formed between an outer wall and an inner wall, without getting into touch or contact with either of the two walls. The temperature sensor can be enwrapped in a multilayer thermal insulation film. The disadvantage of this solution is that the temperature sensor must be installed in the vacuum insulation panel.

### SUMMARY

The underlying technical problem of the present invention is to provide an apparatus for determining the thermal insulation properties of vacuum insulation elements, which allows a reliable, cost-effective and simple determination of the quality of vacuum insulation elements. Furthermore, the object of the invention is to provide a method for determining the thermal insulation properties of vacuum insulation elements, which enables an accurate and reliable determination of the temperature progression.

### BRIEF DESCRIPTION OF THE DRAWINGS

The invention is explained in more detail below with reference to drawings. In the drawings:

FIG. 1 shows a schematic representation of an apparatus for determining the thermal insulation properties of vacuum insulation elements according to the invention, with a temperature-measuring sensor at the first side surface and a temperature-measuring sensor at the second side surface.

FIG. 2 shows a side view of an apparatus for determining the thermal insulation properties of vacuum insulation elements according to the invention, with a temperature-measuring sensor at the first side surface and a temperature-measuring sensor at the second side surface.

FIG. 3 shows a plan view of an apparatus for determining the thermal insulation properties of vacuum insulation elements according to the invention, with two vacuum insulation elements, each having a temperature-measuring sensor.

FIG. 4 shows a representation of the temperature progression across the insulation thickness of a vacuum insulation element measured with an apparatus for determining the thermal insulation properties of vacuum insulation elements according to the invention with a temperature-measuring sensor on the first side surface and a temperature-measuring sensor on the second side surface.

FIG. 5 shows a representation of the temperature progression over time measured on vacuum insulation elements with different thermal insulation properties; and

FIG. 6 shows a representation of the temperature difference over time measured on vacuum insulation elements with different thermal insulation properties.

### DETAILED DESCRIPTION

The apparatus according to the invention is defined by the features of independent claim 1. Advantageous aspects constitute the subject matter of the respective subordinate claims.

The invention encompasses an apparatus for determining the thermal insulation properties of vacuum insulation elements, comprising at least one vacuum insulation element having a first side surface and a second side surface, at least one temperature-measuring sensor that is arranged on the first side surface and/or the second side surface, and a data processing unit for receiving, evaluating and outputting the temperature data provided by the temperature-measuring sensor. This has the advantage that the temperature on the internal or external side surfaces can be determined precisely.

It is particularly advantageous if the apparatus comprises at least two temperature-measuring sensors, and the first temperature-measuring sensor is arranged on the first side surface and the second temperature-measuring sensor, lying opposite to the first temperature-measuring sensor, is arranged on the second side surface of the vacuum insulation element. This makes it possible to measure the temperature on the inside and outside of the vacuum insulation element, allowing a temperature difference to be calculated and conclusions to be drawn about the quality of the insulation.

It has been found to be advantageous if at least two vacuum insulation elements, each having at least one temperature-measuring sensor, are arranged on the first side surface and/or the second side surface relative to one another in such a way that the temperature-measuring sensors are each aligned in a first direction. This allows the temperature to be measured over a larger area and conclusions to be drawn about the temperature progression along a side surface.

According to a preferred aspect, the vacuum insulation element is a vacuum insulation panel. Thus, temperature measurements can also be performed on particularly space-saving components.

Advantageously, one to ten, preferably four, particularly preferably two temperature-measuring sensors are arranged on the first side surface and/or the second side surface lying opposite to the first side surface. This makes it possible to determine the thermal insulation properties of the vacuum insulation element reliably and redundantly.

Another advantageous aspect provides that the temperature-measuring sensors are each arranged in the center of the first side surface and/or the second side surface. This allows the temperature to be measured at a defined location or spot on the vacuum insulation element.

The invention also relates to a method for determining the thermal insulation properties of vacuum insulation panels using an apparatus comprising the steps of:
a. providing at least one vacuum insulation element with at least one temperature-measuring sensor on the first side surface and/or the second side surface;
b. detecting a temperature T_{a,0} on the first side surface and/or the second side surface by means of a temperature-measuring sensor at a point in time t₀;
c. communicating the temperature T_{a,0} to the data processing unit;
d. detecting a temperature T_{a,1} on the first side surface and/or the second side surface by means of a temperature-measuring sensor at a point in time t₁;
e. communicating the temperature T_{a,1} to the data processing unit;
f. repeating steps b)-e) until reaching a point in time t_{end};
g. evaluating the temperature progression from T_{a,0} to T_{a,end} using the data processing unit.

This enables accurate and reliable determination of the temperature progression along the vacuum insulation element.

According to a preferred aspect, the method comprises the steps of:
a. providing an apparatus with at least two vacuum insulation elements, each having at least one temperature-measuring sensor on the first side surface and/or the second side surface, the vacuum insulation elements being arranged relative to one another in such a way that the temperature-measuring sensors are located opposite to one another;
b. detecting a temperature T_{a,0} on the first side surface and/or the second side surface T_{b,0} by means of a temperature-measuring sensor at a point in time t₀;
c. communicating the temperatures T_{a,0} and T_{b,0} to the data processing unit;
d. detecting a temperature T_{a,1} on the first side surface and/or the second side surface T_{b,1} by means of a temperature-measuring sensor at a point in time t₁;
e. communicating the temperatures T_{a,1} and T_{b,1} to the data processing unit;
f. forming a differential value ΔT=T_{a,0} and T_{b,0} by means of the data processing unit;
g. repeating steps b)-f) until reaching a point in time t_{end};
h. evaluating the temporal progression of the differential value ΔT by means of the data processing unit.

In this way, a temperature difference between two vacuum insulation elements can be determined, which allows conclusions to be drawn about the thermal insulation properties and enables a comparison between the vacuum insulation elements.

The method advantageously comprises the steps of:
a. providing at least one vacuum insulation element (1) with at least one temperature-measuring sensor (4) on the first side surface (2) and/or the second side surface (3);
b. detecting a temperature T₀ on the first side surface (2) and/or the second side surface (3) by means of a temperature-measuring sensor (4) at a point in time to;
c. communicating the temperature T₀ to the data processing unit;
d. outputting the temperature T₀ by means of the data processing unit;
e. repeating steps b)-d) until reaching a point in time t_{end};
f. evaluating the temperature progressions between the points in time t₀ and t_{end}.

An advantageous technical aspect provides for the use of an apparatus in a method for determining the thermal insulation properties of vacuum insulation elements, wherein at least one vacuum insulation element is arranged in a container for temperature-controlled transport. This enables use in mobile applications such as temperature-controlled transport in containers or boxes.

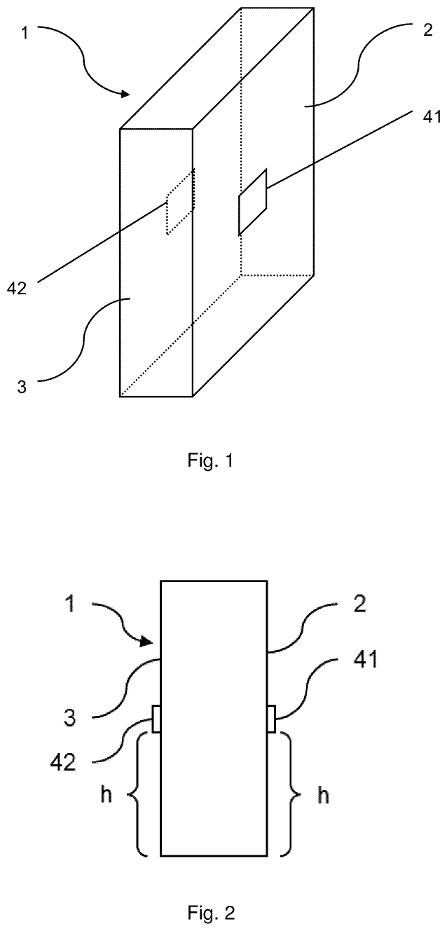

FIG. 1 shows an apparatus for determining the thermal insulation properties of vacuum insulation elements, comprising at least one vacuum insulation element 1 having a first side surface 2 and a second side surface 3, at least one temperature-measuring sensor 4, which is arranged on the first side surface 2 and/or the second side surface 3, and a data processing unit for receiving, evaluating and outputting the temperature data provided by the temperature-measuring sensor 4. The temperature-measuring sensors 41, 42 are each arranged in the center of the first side surface 2 and/or the second side surface 3.

The temperature-measuring sensor 4, for example, is a heat flow sensor, a liquid-filled temperature sensor, a semiconductor temperature sensor (NTC, PTC), a pyrometer, a quartz crystal microbalance, an acoustic temperature sensor, a fiber Bragg grating sensor, a surface temperature sensor, a resistance temperature detector (RTD), a thermocouple, an infrared sensor or an infrared camera, a thermistor, a bimetallic transmitter, a temperature transmitter or a laser scanner.

It is conceivable that one to ten, preferably four, particularly preferably two, temperature-measuring sensors 41, 42 are arranged on the first side surface 2 and/or the first side surface 2 lying opposite to the second side surface 3.

In FIG. 2 an apparatus comprising at least two temperature-measuring sensors 41, 42 is shown, the first temperature-measuring sensor 41 being arranged on the first side surface 2 and the second temperature-measuring sensor 42, lying opposite to the first temperature-measuring sensor 41, being arranged on the second side surface 3 of the vacuum insulation element 1.

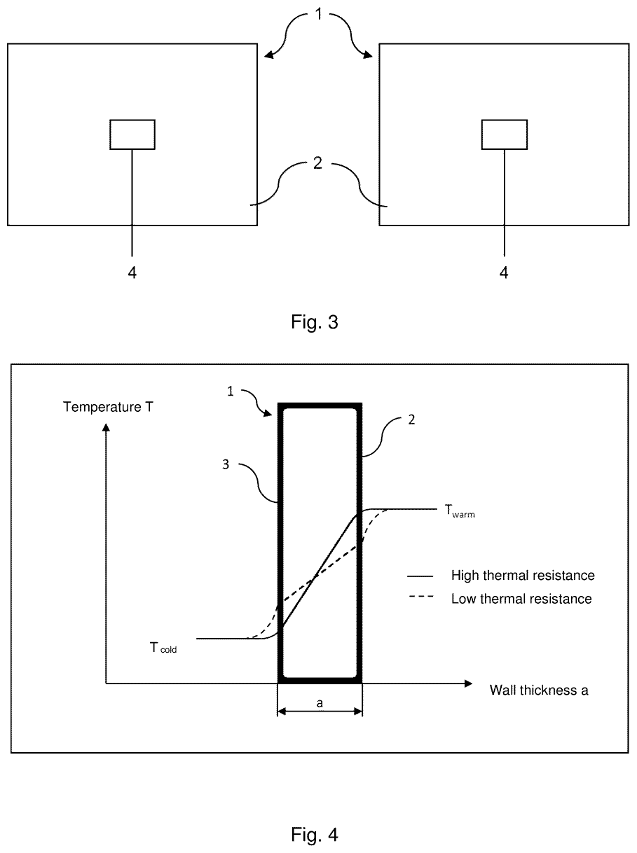

FIG. 3 shows an apparatus in which at least two vacuum insulation elements 1, each having at least one temperature-measuring sensor 4, are arranged on the first side surface 2 and/or the second side surface 3 relative to one another in such a way that the temperature-measuring sensors 4 are each aligned in a first direction. For example, the vacuum insulation element 1 is a vacuum insulation panel. The vacuum insulation panel comprises an inner body of fumed silica and/or inorganic fibers and/or organic fibers and/or inorganic aerogels and/or organic aerogels and/or nanoporous polymer foams and/or microporous polymer foams and/or porous minerals. The body corresponds to the load-bearing, open-pored, porous core material. Materials that can be used to manufacture the core material include, for example, various fumed silicas (pyrogenic SiO2), various precipitated silicas, microporous polymer foams (e.g. open-cell polyurethane rigid foam, open-cell polystyrene rigid foams, other open-cell polymeric rigid foams), various inorganic glass fibers, various natural fibers (e.g. wood fibers, jute fibers, hemp fibers), inorganic aerogels (e.g. SiO2-based aerogels), organic aerogels (e.g. based on lignins, celluloses, lignocelluloses, alginates or mixtures thereof), nanoporous polymer foams, porous minerals (e.g. volcanic glasses or various perlites), glass beads or hollow glass beads and/or mixtures thereof.

FIG. 4 shows a representation of the temperature progression across the thickness of a vacuum insulation element 1, measured using an apparatus for determining the thermal insulation properties of vacuum insulation elements according to the invention, with a temperature-measuring sensor at the first side surface 2 and a temperature-measuring sensor at the second side surface 3. To establish the temperature progression, an apparatus for determining the thermal insulation properties of vacuum insulation elements is used, with at least one vacuum insulation element 1 being arranged in a container for temperature-controlled transport. The side walls of the container consist of one or more vacuum insulation panels, which all include the apparatus for determining the thermal insulation properties of vacuum insulation elements according to the invention.

Furthermore, applications of an apparatus for determining the thermal insulation properties of vacuum insulation elements are hot water storage tanks, industrial cooling/refrigeration units, pipelines (e.g. deep-sea pipelines), electrical energy storage units (home storage), household appliances such as stoves or ovens, refrigerators, etc.

Two theoretical temperature progressions are shown across the thickness of the vacuum insulation element 1 with high thermal resistance and with low thermal resistance. High thermal resistance corresponds to a vacuum insulation element 1 with a high thermal insulation property, and low thermal resistance corresponds to a vacuum insulation element 1 with a low thermal insulation property.

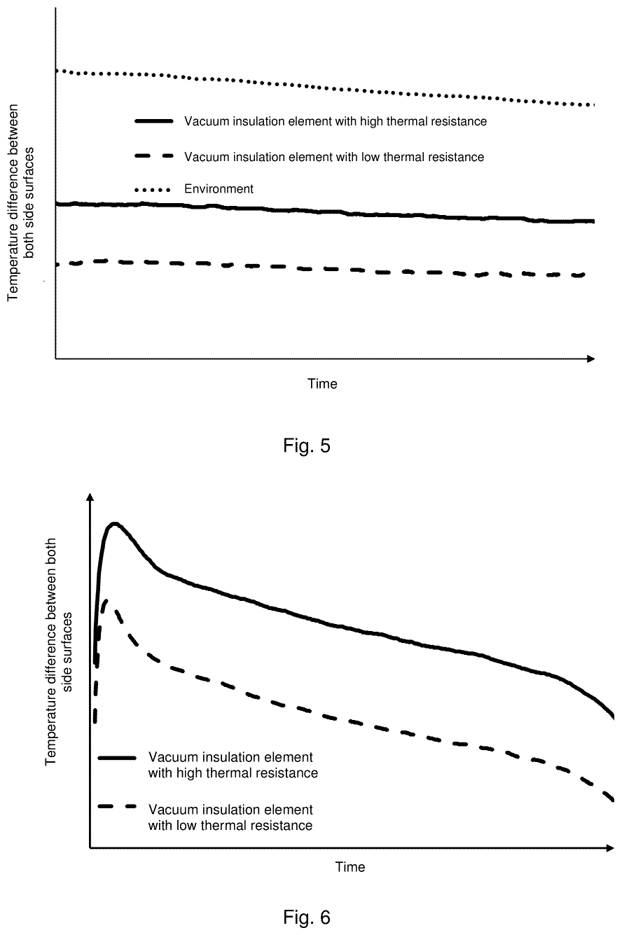

FIG. 5 shows a representation of the temperature progression over time measured on vacuum insulation elements with different thermal insulation properties. The method for capturing the temperature progression comprises the steps of:
a. providing at least one vacuum insulation element 1 with at least one temperature-measuring sensor 4 on the first side surface 2 and/or the second side surface 3;
b. detecting a temperature T_{a,0} on the first side surface 2 and/or the second side surface 3 by means of a temperature-measuring sensor 4 at a point in time t₀;
c. communicating the temperature T_{a,0} to the data processing unit;
d. detecting a temperature T_{a,1} on the first side surface 2 and/or the second side surface 3 by means of a temperature-measuring sensor 4 at a point in time t₁;
e. communicating the temperature T_{a,1} to the data processing unit;
f. repeating steps b)-e) until reaching a point in time t_{end};
g. evaluating the temperature progression from T_{a,0} to T_{a,end} by means of the data processing unit.

On the basis of knowledge of the thermal conductivity and the thickness of the installed vacuum insulation element 1, as well as on the basis of empirical values, conclusions can be drawn about the heat transfer coefficient of the vacuum insulation element 1.

Knowing the inside and outside temperature, as well as the temperatures at the first side surface 2 and/or the second side surface 3 of the vacuum insulation element 1, the expected surface temperatures can be estimated.

In the case of an intact vacuum insulation element 1, the temperature on the warm side (environment) of the first side surface 2 of the vacuum insulation element 1 should be close to the outside temperature.

Likewise, in the case of an intact vacuum insulation element 1, the surface temperature of the vacuum insulation element 1 on the second side surface 3 with the low temperature (interior) should be close to the inside temperature.

Of course, the situation is also conceivable exactly the opposite, with the temperature inside a container being high and the temperature on the outside being low.

If the vacuum insulation element 1 is damaged, the thermal conductivity and thus the surface temperature of the vacuum insulation element 1, or the temperature difference between the surface temperature and the ambient temperature, will change.

In the case of the first side surface 2 (outer side), the surface temperature of the vacuum insulation element 1 would drop significantly. By contrast, the second side surface 3 (inner side) would heat up. This means that the temperature difference ΔT of the surface temperatures would decrease.

If a vacuum insulation element 1 is observed over a longer period of time, the change in the temperature difference ΔT of the surface temperatures can be used to determine whether the VIP is damaged. It is conceivable that such an evaluation could be carried out using AI.

In the case of a vacuum insulation element 1 with a high thermal insulation property, the surface temperature of the vacuum insulation element 1 should be closer to the ambient temperature than in the case of a vacuum insulation element 1 with a low thermal insulation property.

FIG. 6 shows a representation of the temperature difference over time measured on vacuum insulation elements with different thermal insulation properties. The method for determining the temperature difference comprises the steps of:
a. providing an apparatus with at least two vacuum insulation elements 1, each having at least one temperature-measuring sensor 41, 42 on the first side surface 2 and/or the second side surface 3, the vacuum insulation elements 1 being arranged relative to one another in such a way that the temperature-measuring sensors 41, 42 are located opposite to one another;
b. detecting a temperature T_{a,0} on the first side surface 2 and/or the second side surface 3 T_{b,0} by means of a temperature-measuring sensor 41, 42 at a point in time t₀;
c. communicating the temperatures T_{a,0} and T_{b,0} to the data processing unit;
d. detecting a temperature T_{a,1} on the first side surface 2 and/or the second side surface 3 T_{b,1} by means of a temperature-measuring sensor 41, 42 at a point in time t₁;
e. communicating the temperatures T_{a,1} and T_{b,1} to the data processing unit;
f. forming a differential value ΔT=T_{a,0} and T_{b,0} by means of the data processing unit;
g. repeating steps b)-f) until reaching a point in time t_{end};
h. evaluating the temporal progression of the differential value ΔT by means of the data processing unit.

This can be used to draw conclusions about different vacuum insulation elements 1 in a system. This means that the ΔT of the surface temperatures between the first side surface 2 and the second side surface 3 (outside and inside) of the individual vacuum insulation elements 1 are compared to each other. Intact vacuum insulation elements 1 exhibit a higher temperature difference ΔT compared to a damaged vacuum insulation element 1.

The evaluation of the temporal progression of the temperature difference ΔT of a vacuum insulation element 1, but also of vacuum insulation elements 1 in an inter-elemental-system, can be carried out manually, preferably automatically, particularly preferably by a neural network or artificial intelligence. If a certain deviation in temperature difference is exceeded, the corresponding vacuum insulation element 1 can be considered defective and should be replaced.

It is also conceivable to measure the temperature progression along a vacuum insulation element 1 using a method comprising the following steps of:
a. providing at least one vacuum insulation element 1 with at least one temperature-measuring sensor 4 on the first side surface 2 and/or the second side surface 3;
b. detecting a temperature T₀ at the first side surface 2 and/or the second side surface 3 by means of a temperature-measuring sensor 4 at a point in time t₀;
c. communicating the temperature T₀ to the data processing unit;
d. outputting the temperature T₀ by means of the data processing unit;
e. repeating steps b)-d) until reaching a point in time t_{end};
f. evaluating the temperature progressions between the points in time t₀ and t_{end}.

The invention claimed is:

1. Apparatus for determining the thermal insulation properties of vacuum insulation elements, comprising at least one vacuum insulation element having a first side surface and a second side surface, at least one temperature-measuring sensor which is arranged on the first side surface and/or the second side surface, and a data processing unit for receiving, evaluating and outputting the temperature data provided by the temperature-measuring sensor.

2. Apparatus according to claim 1, comprising at least two temperature-measuring sensors, the first temperature-measuring sensor being arranged on the first side surface and the second temperature-measuring sensor, lying opposite to the first temperature-measuring sensor, being arranged on the second side surface of the vacuum insulation element.

3. Apparatus according to claim 1, wherein at least two vacuum insulation elements each having at least one temperature-measuring sensor are arranged on the first side surface and/or the second side surface relative to one another in such a way that the temperature-measuring sensors are each aligned in a first direction.

4. Apparatus according to claim 1, wherein the vacuum insulation element is a vacuum insulation panel.

5. Apparatus according to claim 1, wherein one to ten, preferably four, particularly preferably two temperature-measuring sensors are arranged on the first side surface and/or the second side surface lying opposite to the first side surface.

6. Apparatus according to claim 1, wherein the temperature-measuring sensors are each arranged in the center of the first side surface and/or the second side surface.

7. Method for determining the thermal insulation properties of vacuum insulation elements using an apparatus according to claim 1, comprising the steps of:
a. providing at least one vacuum insulation element with at least one temperature-measuring sensor on the first side surface and/or the second side surface;
b. detecting a temperature T_{a,0} on the first side surface and/or the second side surface by means of a temperature measuring-sensor at a point in time t₀;
c. communicating the temperature T_{a,0} to the data processing unit;
d. detecting a temperature T_{a,1} on the first side surface and/or the second side surface by means of a temperature-measuring sensor at a point in time t₁;
e. communicating the temperature T_{a,1} to the data processing unit;
f. repeating steps b)-e) until reaching a point in time t_{end};
g. evaluating the temperature progression from T_{a,0} to T_{a,end} by means of the data processing unit.

8. Method according to claim 7, comprising the steps of:
a. providing an apparatus with at least two vacuum insulation elements, each having at least one temperature-measuring sensor, on the first side surface and/or the second side surface, the vacuum insulation elements being arranged relative to one another in such a way that the temperature-measuring sensors lie opposite to one another;
b. detecting a temperature T_{a,0} at the first side surface and/or the second side surface T_{b,0} by means of a temperature-measuring sensor at a point in time t₀;
c. communicating the temperatures T_{a,0} and T_{b,0} to the data processing unit;
d. detecting a temperature T_{a,1} at the first side surface and/or the second side surface T_{b,1} by means of a temperature-measuring sensor at a point in time t₁
e. communicating the temperatures T_{a,1} and T_{b,1} to the data processing unit;
f. forming a differential value ΔT=T_{a,0} and T_{b,0} by means of the data processing unit;
g. repeating steps b)-f) until reaching a point in time t_{end};
h. evaluating the temporal progression of the differential value ΔT by means of the data processing unit.

9. Method according to claim 7, comprising the steps of:
a. providing at least one vacuum insulation element having at least one temperature-measuring sensor on the first side surface and/or the second side surface;
b. detecting a temperature T₀ on the first side surface and/or the second side surface by means of a temperature-measuring sensor at a point in time t₀;
c. communicating the temperature T₀ to the data processing unit;
d. outputting the temperature T₀ by means of the data processing unit;
e. repeating steps b)-d) until reaching a point in time t_{end};
f. evaluating the temperature progressions between the points in time t₀ and t_{end}.

10. Use of an apparatus according to claim 1 for determining the insulating properties of vacuum insulation elements, at least one vacuum insulation element being arranged in a container for temperature-controlled transport
